(19) United States
(12) Patent Application Publication
(10) Pub. No.: US 2013/0105163 A1
(43) Pub. Date: May 2, 2013

(54) Method of opening productive formations and a working fluid provided therefor

(71) Applicants: Anatoli Nikouline, Aurora (CA); Nikolai Korvet, St-Peterburg (RU)

(72) Inventors: Anatoli Nikouline, Aurora (CA); Nikolai Korvet, St-Peterburg (RU)

(21) Appl. No.: 13/317,998

(22) Filed: Nov. 2, 2011

(51) Int. Cl. E21B 43/11; C09K 8/68; E21B 37/00

(52) U.S. Cl. 166/298; 166/311; 507/203; 507/269; 507/266; 507/268

(57) ABSTRACT

A method of opening productive formations by slot-perforating includes providing a working fluid including water, an abrasive component, and an additive, supplying the working fluid at a high pressure towards a formation so as to cut slots and to provide an inflow of oil, gas and hydrogeological liquid from the formation into a borehole, and using the additive, so as to reduce density of the working fluid and therefore to increase a speed of jet of the working fluid due to increase of kinetic energy of particles of the abrasive component.

### BACKGROUND OF THE INVENTION

The present invention relates to opening of productive formations for oil and gas excavations.

It is known to open productive formations in oil, gas and hydrogeological wells by forming in a productive formation of slot-shaped passages of substantial depth and area, which enhances unloading of stressed condition of rocks and near-well-zone and an increase of filtration area. Depth of penetration of a working medium jet depends not only on the pressure and energy of the jet and the strength of obstacle to it's, which includes a casing, a cement ring and density of a formation, but also on hydrostatic pressure in a borehole and interior counter pressure of the formation itself. It is therefore desirable to increase efficiency of the working medium jets for opening of productive formations.

### SUMMARY OF THE INVENTION

It is therefore an object of the present invention to provide a method of opening productive formations and working fluid provided therefore which is a further improvement of the existing methods and working fluids.

In keeping with these objects and with others which will become apparent hereinafter, one feature of the present invention resides, briefly stated in a method of opening productive formations by slot-perforating, comprising the steps of providing a working fluid including water, an abrasive component, and an additive; and supplying the working fluid at a high pressure towards a formation so as to cut slots and to provide an inflow of oil, gas or hydrogeological liquid from the formation into a borehole; and the additive for reduce density of the working fluid and therefore to increase a speed of jet of the working fluid due to an increase of kinetic energy of particles of the abrasive component. The density of addition for the working fluid should be less than density of water. As such additives can be any side-petroleum products, gasoline, kerosene, diesel fuel, alcohol, acetone, ammonia, methanol, motor oils and vegetable oils. Everything depends from the financial costs and the availability.

Another feature of the present invention resides in a working fluid for opening productive formations by slot-perforating, by supplying the working fluid at a high pressure towards a formation so as to cut slots and to provide an inflow of oil, gas or hydro-geological liquid from the formation into a borehole, the working fluid comprising water, an abrasive component, and an additive, which reduces density of the working fluid and therefore increases a speed of jet of the working fluid due to an increase of kinetic energy of particles of the abrasive component. The density of addition for the working fluid should be less than density of water.

When the method is performed and the working fluid is used in accordance with the present invention, the additive towers the density of the working fluid. This leads to increase of a speed of the working fluid jet and in particular to an increase of kinetic energy of the abrasive particles contained in it. In addition cavitation processes are developed, cleaning of the perforated passage is improved, and washing of the borehole is improved as well.

In accordance with another feature of the present invention said additive in the working fluid is in a quantity from 1% to 5% of the working fluid.

The abrasive component can include abrasive particles of the materials such as: abrasive quartz sand with the next grain size:
1. 63% (e 630 microns-0.63 mm) if used nozzles diameter 3 mm
2. 34% (640-1250 microns-0.64-1.25 mm) if nozzles diameter 3.5 mm
3. 3% (1250-2500 microns-1.25-2.5 mm) if nozzles diameter 4.0 mm
4. 0% (>2500 microns->2.5mm) if used nozzles diameter 6 mm

The composition of the working fluid can include
the layer water from 91% to 97%,
the abrasive component from 2% to 4%;
additive component from 1% to 5%.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### DESCRIPTION OF THE PREFERRED EMBODIMENTS

In accordance with the present invention opening of productive formations for oil, gas, and hydro-geological wells is performed by a slot perforation of the formations.

A perforator including a vertical supplying channel and transverse nozzles extending from the channel transversely and opening outwardly is lowered into a borehole. A working fluid is introduced into the channel and exits at a high speed, for example 200-250 miles/hour, towards the formation.

It cuts through the casing and the concrete ring and produces slot-shaped passages or slots in the formation. A hydrodynamic communication of the formation with the borehole is thereby established to provide a flow of oil, gas or hydro-geological liquid into the borehole.

In accordance with the present invention the working fluid includes:
the layer water,
abrasive component (abrasive quartz sand),
additive (less than density of water: any side-petroleum products, gasoline, kerosene, diesel fuel, alcohol, acetone, ammonia, methanol, motor oils and vegetable oils),

As the additives can be any side-petroleum products, gasoline, kerosene, diesel fuel, alcohol, acetone, ammonia, methanol, motor oils and vegetable oils, is used in the working fluid.

The additives is provided to provide an inflow of oil, gas or hydrogeological liquid from the formation into a borehole; and using as the additive, so as to reduce density of the working fluid and therefore to increase a speed of jet of the working fluid due to an increase of kinetic energy of particles of the abrasive component.

The additives are used in the working fluid in a quantity from weight % to 5 weight % of the working fluid.

The abrasive component can include abrasive particles of materials, such as: abrasive quartz sand with the next grain size:
5. 63% (<630 microns-0.63 mm) if used nozzles diameter 3 mm
6. 34% (640-1250 microns-0.64-1.25 mm) if nozzles diameter 3.5 mm
7. 3% (1250-2500 microns-1.25-2.5 mm) if nozzles diameter 4.0 mm
8. 0% (>2500 microns->2.5mm) if used nozzles diameter 6 mm

The working fluid can have the following composition:
the layer water from 91% to 97%,
the abrasive component from 2% to 4%;
additive component from 1% to 5%.

Herein below some examples of the working fluids in accordance with the present invention are provided.

### EXAMPLE I

| | |
|---|---|
| Layer water | 97% |
| Abrasive (abrasive garnet sand) | 2% |
| Additives (diesel fuel) | 1% |

### EXAMPLE II

| | |
|---|---|
| Layer water | 91% |
| Abrasive (abrasive quartz sand) | 4% |
| Additives (methanol) | 5% |

When the method is performed and the working fluid Is used in accordance with the present invention, the additives lower the density of the working fluid. This leads to increase of a speed of the working fluid jet and in particular to an increase of kinetic energy of the abrasive particles contained in it. In addition cavitation processes are developed, cleaning of the perforated passage is improved, and washing of the borehole is improved as well.

It will be understood that each of the elements described above, or two or more together, may also find a useful application in other types of methods and compositions differing from the type described above.

While the invention has been illustrated and described as embodied in a method of opening productive formations and a working fluid provided therefore, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of opening productive formations by slot-perforating, comprising the steps of providing a working fluid including water, an abrasive component, and an additive; supplying the working fluid at a high pressure towards a formation so as to cut slots and to provide an inflow of oil, gas and hydrogeological liquid from the formation into a borehole; and using the additive, so as to reduce density of the working fluid and therefore to increase a speed of jet of the working fluid due to increase of kinetic energy of particles of the abrasive component, and wherein the additive is a side-petroleum product selected from the group consisting of gasoline, kerosene, diesel fuel and motor oil.

2. A method as defined in claim 1, wherein said using additives in the working fluid in a quantity from 1% to 5% of the working fluid.

3. A method as defined in claim 1; further comprising using as the abrasive component abrasive particles of a material selected from the group consisting of abrasive materials: sand+quartz, garnet, glass, plastic, diamond technical supplements.

4. A method as defined in claim 1; further comprising using as said water a formation water.

5. A method as defined in claim 1; further comprising providing a composition of the working fluid including
layer water from 91% to 97%,
the abrasive component from 2% to 4%;
additive component from 1% to 5%.

6. A method as defined in claim 1; further comprising selecting additive components in a quantity causing cavitation processes, cleaning of a perforated slot, and washing of the borehole.

7. A working fluid for opening productive formations by slot-perforating, by supplying the working fluid at a high pressure towards a formation so as to cut slots and to provide an inflow of oil, gas or hydrogeological liquid from the formation into a borehole, comprising water, an abrasive component, an additive, and wherein the additive is a side-petroleum product selected from the group consisting of gasoline, kerosene, diesel fuel, and motor oil, which reduces density of the working fluid and therefore increases a speed of jet of the working fluid due to an increase of kinetic energy of particles of the abrasive component.

8. A working fluid as defined in claim 7, wherein said additive in the working fluid is in a quantity from 1% to 5% of the working fluid.

9. A working fluid for as defined in claim 7; wherein the abrasive component includes abrasive particles of a material selected from the group consisting of abrasive materials: sand+quartz, garnet, glass, plastic, diamond technical supplements.

10. A working fluid as defined in claim 7, wherein said water is a formation water.

11. A working fluid as defined in claim 7, including:
layer water from 91% to 97%,
the abrasive component from 2% to 4%;
additive component from 1% to 5%.

12. A working fluid as defined in claim 7, wherein said additive is provided in a quantity causing cavitation processes, cleaning of a perforated slot, and washing of the borehole.
